(19) United States
(12) Patent Application Publication
(10) Pub. No.: US 2025/0096434 A1
(43) Pub. Date: Mar. 20, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta Takasu, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/802,069

(22) Filed: Aug. 13, 2024

(30) Foreign Application Priority Data
Sep. 20, 2023 (JP) 2023-152122

(51) Int. Cl. H01M 50/533; H01M 10/04; H01M 50/107; H01M 50/536; H01M 50/538; H01M 50/567

(52) U.S. Cl. CPC H01M 50/533; H01M 10/0431; H01M 50/107; H01M 50/536; H01M 50/538; H01M 50/567

(57) ABSTRACT

In a power storage cell, a current collector plate includes a central portion, an outer peripheral edge, a spoke, a first piece, and a second piece. The central portion is disposed to overlap with a center of the wound electrode body when viewed from an The outer peripheral edge is located on the outer peripheral side of the 5 axial direction. central portion. One of the outer peripheral edge and the central portion is connected to the case to electrically connect the current collector plate to the first external terminal. The spoke connects the central portion and the outer peripheral edge. The first piece extends from the central portion toward the outer peripheral edge and is connected to the first electrode. The second piece extends from the outer peripheral edge toward the center portion and is connected to the first electrode.

### CROSS REFERENCE TO RELATED APPLICATIONS

This non-provisional application is based on Japanese Patent Application No. 2023-152122 filed on Sep. 20, 2023 with the Japan Patent Office, the entire contents of which are hereby incorporated by reference.

### BACKGROUND

### Field

The present disclosure relates to a power storage cell.

### Description of the Background Art

Japanese Patent No. 3324372 discloses a cylindrical battery in which an electrode group consisting of a positive electrode, a negative electrode, and a separator is spirally wound and housed in a battery case. A tabless method is disclosed as a method of connecting a lead of the positive electrode. The lead provided on a current collector plate of the positive electrode is welded to a back surface of a lid. The overlapping lead of the negative electrode is spot-welded to an inner bottom of the battery case.

### SUMMARY

A power storage cell such as the cylindrical battery disclosed in Japanese Patent No. 3324372 may be charged by rapid charging. When the power storage cell is rapidly charged, it is desirable for the temperature of the power storage cell to rise to some extent. However, in order to maintain the functions of the power storage cell, it is required to prevent excessive heat from being generated in the power storage cell.

The present disclosure has been made in view of the problem mentioned above, and an object of the present disclosure is to provide a power storage cell that can generate moderate heat when energized.

The power storage cell according to the present disclosure includes a wound electrode body, a case, and a current collector plate. The wound electrode body includes a first electrode and a second electrode. The case houses the wound electrode body and includes a first external terminal. The current collector plate is disposed inside the case on one side of the wound electrode body in the axial direction. The current collector plate is provided to electrically connect the first electrode and the first external terminal. The current collector plate includes a central portion, an outer peripheral edge, a spoke, a first piece, and a second piece. The central portion is disposed to overlap with a center of the wound electrode body when viewed from the axial direction. The outer peripheral edge is located on an outer peripheral side of the central portion. One of the outer peripheral edge and the central portion is connected to the case to electrically connect the current collector plate to the first external terminal. The spoke connects the central portion and the outer peripheral edge. The first piece extends from the central portion toward the outer peripheral edge and is connected to the first electrode. The second piece extends from the outer peripheral edge toward the center portion and is connected to the first electrode.

In the configuration described above, firstly, when for example the outer peripheral edge is connected to the case, a path on the current collector plate in which the first piece, the central portion, the spoke, and the outer peripheral edge are connected in this order is relatively long. Therefore, when the electricity storage cell is energized, the current collector plate generates relatively large heat on the path. On the other hand, a path on the current collector plate which is constituted only by the second piece and the outer peripheral edge is relatively short. Therefore, heat generated in the path during energization is relatively small. Accordingly, it is possible to provide a power storage cell that can generate moderate heat during energization. Secondly, when for example the central portion is connected to the case, a path on the current collector plate in which the second piece, the outer peripheral edge, the spokes, and the central portion are connected in this order is relatively long. Therefore, when the electricity storage cell is energized, the current collector plate generates relatively large heat on the path. On the other hand, a path on the current collector plate which is constituted only by the first piece and the central portion is relatively short. Therefore, heat generated in the path during energization is relatively small. Accordingly, it is possible to provide a power storage cell that can generate moderate heat during energization.

In the power storage cell according to the present disclosure, it is preferable that the first piece and the second piece are arranged side by side in the circumferential direction centered on the central portion with the spoke interposed therebetween.

According to the configuration described above, a long path on the current collector plate in which the heat generation during energization is relatively large and a short path on the current collector plate in which the heat generation is relatively small are arranged side by side in the circumferential direction. Thus, it is possible to reduce the deviation of the heat distribution in the circumferential direction when the current collector plate is energized.

In the power storage cell according to the present disclosure, it is preferable that the first piece and the second piece are arranged in a radial direction centered on the center portion. According to this configuration, the first piece and the second piece can be arranged compactly.

In the power storage cell according to the present disclosure, it is preferable that the first piece and the second piece are welded to the first electrode 11A.

According to the configuration described above, the first piece and the second piece are more reliably fixed to the first electrode. Therefore, a conductive path through the first piece and a conductive path through the second piece in the current collector plate are formed more reliably.

In the power storage cell according to the present disclosure, it is preferable that the case includes a cylindrical wall that covers the entire outer periphery of the wound electrode body. The outer peripheral edge is connected to the cylindrical wall to electrically connect the current collector plate to the first external terminal.

According to the configuration described above, the conductive path from the current collector plate to the first external terminal includes the cylindrical wall having a relatively large outer surface area. Therefore, the heat generated when the conduction path is energized can be easily dissipated from the outer surface of the cylindrical wall.

In the power storage cell according to the present disclosure, it is preferable that the first external terminal is disposed to overlap with the central portion when viewed in the axial direction. The central portion is connected to the case to electrically connect the current collector plate to the first external terminal.

According to the configuration described above, it is possible to shorten the conductive path from the current collector plate to the first external terminal, which makes it possible to reduce heat generated in the conductive path.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a power storage cell according to a first embodiment;

FIG. 2 is a cross-sectional view of the power storage cell in FIG. 1 taken along line II-II in the direction of the arrow;

FIG. 3 is a cross-sectional view of the power storage cell in FIG. 1 taken along line III-III;

FIG. 4 is a partially exploded perspective view of a wound electrode body;

FIG. 5 is an exploded perspective view of the power storage cell according to the first embodiment;

FIG. 6 is another exploded perspective view of the power storage cell according to the first embodiment;

FIG. 7 is a plan view of a negative electrode current collector plate according to the first embodiment;

FIG. 8 is a cross-sectional view of a power storage cell according to a second embodiment;

FIG. 9 is a plan view of a negative electrode current collector plate according to the second embodiment;

FIG. 10 is a cross-sectional view of a power storage cell according to a third embodiment;

FIG. 11 is another cross-sectional view of the power storage cell according to the third embodiment;

FIG. 12 is an exploded perspective view of the power storage cell according to the third embodiment;

FIG. 13 is another exploded perspective view of the power storage cell according to the third embodiment;

FIG. 14 is a plan view of a positive electrode current collector plate according to the third embodiment;

FIG. 15 is a plan view of a power storage cell according to a fourth embodiment;

FIG. 16 is a plan view of a positive electrode current collector plate according to the fourth embodiment;

FIG. 17 is a cross-sectional view of a power storage cell according to a fifth embodiment; and

FIG. 18 is an exploded perspective view of the power storage cell according to the fifth embodiment.

### DESCRIPTION OF THE PREFERRED EMBODIMENTS

Hereinafter, a power storage cell according to each embodiment of the present disclosure will be described with reference to the drawings. The same or corresponding parts in the drawings are denoted by the same reference numerals, and the description thereof will not be repeated.

### First Embodiment

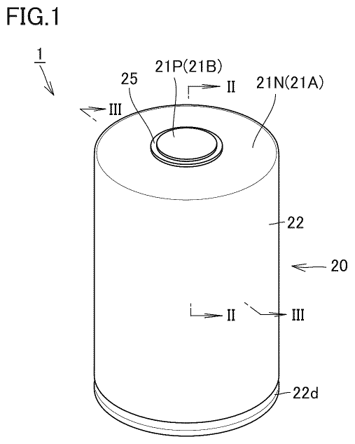

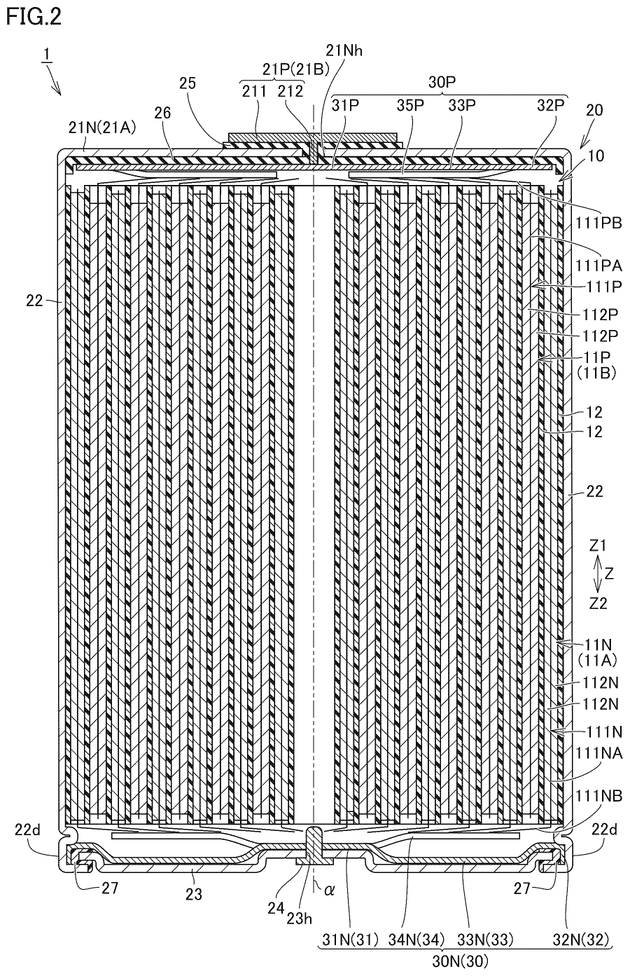

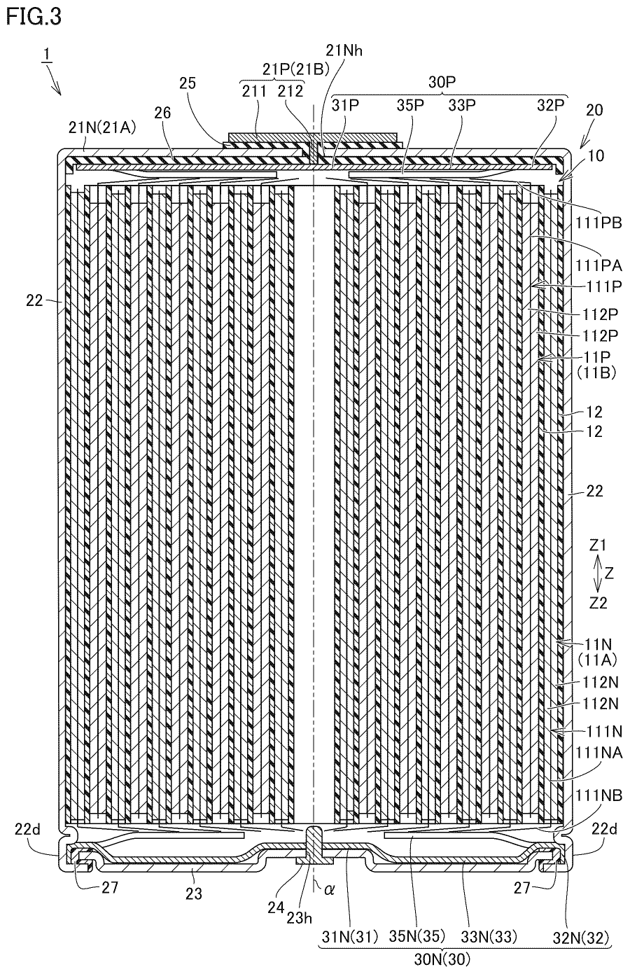

FIG. 1 is a perspective view of a power storage cell according to a first embodiment. FIG. 2 is a cross-sectional view of the power storage cell in FIG. 1 taken along line II-II. FIG. 3 is a cross-sectional view of the power storage cell in FIG. 1 taken along line III-III.

As illustrated in FIGS. 1 to 3, the power storage cell 1 is a cylindrical battery. The power storage cell 1 includes a wound electrode body 10, a case 20, a positive electrode current collector plate 30P, and a negative electrode current collector plate 30N. In the first embodiment, the negative electrode current collector plate 30N is illustrated as an example of a current collector plate (30) in the present disclosure.

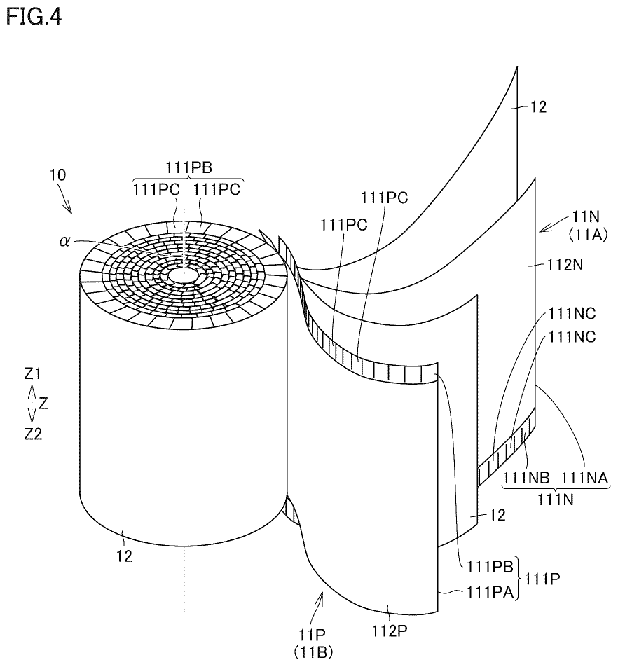

First, the wound electrode body 10 will be described. FIG. 4 is a partially exploded perspective view of the wound electrode body. As illustrated in FIGS. 2 to 4, the wound electrode body 10 is wound in a cylindrical shape. FIG. 4 illustrates a state in which the wound electrode body 10 is partially unwound.

The wound electrode body 10 includes a positive electrode 11P, a negative electrode 11N, and a separator 12. In the wound electrode body 10, the positive electrode 11P, the negative electrode 11N, and the separator 12 are wound about a winding axis a. In the first embodiment, the negative electrode 11N is illustrated as an example of a first electrode (11A) in the present disclosure, and the positive electrode 11P is illustrated as an example of a second electrode (11B) in the present disclosure.

Each of the positive electrode 11P and the negative electrode 11N has a sheet-like outer shape. The wound electrode body 10 is composed of an electrode plate group in which the positive electrode 11P and the negative electrode 11N are wound with the separator 12 interposed therebetween.

The separator 12 is disposed between the positive electrode 11P and the negative electrode 11N. The separator 12 separates the positive electrode 11P and the negative electrode 11N while allowing ions (for example, lithium ions) to move between the positive electrode 11P (positive electrode active material) and the negative electrode 11N (negative electrode active material).

The positive electrode 11P includes a positive electrode current collector 111P and a positive electrode composite material layer 112P. The positive electrode current collector 111P is made of, for example, aluminum.

The positive electrode composite material layer 112P is coated on both surfaces of the positive electrode current collector 111P (a coated positive electrode portion 111PA to be described later) in the radial direction. The positive electrode composite material layer 112P is in close contact with the separator 12. The positive electrode composite material layer 112P is formed by applying a positive electrode slurry to both surfaces of the positive electrode current collector 111P and drying the positive electrode slurry. The positive electrode slurry is prepared by kneading materials of the positive electrode composite material layer 112P (a positive electrode active material, a binder, and the like) and a solvent. The thickness of the positive electrode composite material layer 112P is, for example, 0.1 μm or more and 1000 μm or less.

The positive electrode current collector 111P includes a coated positive electrode portion 111PA and a uncoated positive electrode portion 111PB. The coated positive electrode portion 111PA is a portion of the positive electrode current collector 111P on which the positive electrode composite material layer 112P is coated. In other words, the coated positive electrode portion 111PA is a portion that is coated with the positive electrode composite material layer 112P and thereby is not exposed.

The uncoated positive electrode portion 111PB is a portion of the positive electrode current collector 111P that is not coated with the positive electrode composite material layer 112P and thereby is exposed. The uncoated positive electrode portion 111PB is located on a first direction Z1 side in an axial direction Z than the coated positive electrode portion 111PA. Specifically, the uncoated positive electrode portion 111PB protrudes from the coated positive electrode portion 111PA toward the first direction Z1 side. The uncoated positive electrode portion 111PB is bent inward in the radial direction.

The uncoated positive electrode portion 111PB includes a plurality of extending portions 111PC. The plurality of extending portions 111PC are arranged side by side along the winding direction of the wound electrode body 10.

The negative electrode 11N includes a negative electrode current collector 111N and a negative electrode composite material layer 112N. The negative electrode current collector 111N is made of, for example, copper.

The negative electrode composite material layer 112N is coated on both surfaces of the negative electrode current collector 111N (a coated negative electrode portion 111NA to be described later) in the radial direction. The negative electrode composite material layer 112N is in close contact with the separator 12. The negative electrode composite material layer 112N is formed by applying a negative electrode slurry to both surfaces of the negative electrode current collector 111N and drying the negative electrode slurry. The negative electrode slurry is prepared by kneading materials of the negative electrode composite material layer 112N (a negative electrode active material, a binder, and the like) and a solvent. The thickness of the negative electrode composite material layer 112N is, for example, 0.1 μm or more and 1000 μm or less.

The negative electrode current collector 111N includes a coated negative electrode portion 111NA and a uncoated negative electrode portion 111NB. The coated negative electrode portion 111NA is a portion of the negative electrode current collector 111N on which the negative electrode composite material layer 112N is coated. In other words, coated negative electrode portion 111NA is a portion that is coated with negative electrode composite material layer 112N and thereby is not exposed.

The uncoated negative electrode portion 111NB is a portion of the negative electrode current collector 111N that is not coated with the negative electrode composite material layer 112N and thereby is exposed. The uncoated negative electrode portion 111NB is located on a second direction Z2 side in the axial direction than the coated negative electrode portion 111NA. The second direction Z2 is opposite to the first direction Z1. The uncoated negative electrode portion 111NB protrudes from the coated negative electrode portion 111NA toward the second direction Z2 in the axial direction Z. The uncoated negative electrode portion 111NB is bent inward in the radial direction.

The uncoated negative electrode portion 111NB includes a plurality of extending portions 111NC. The plurality of extending portions 111NC are arranged side by side along the winding direction of the wound electrode body 10.

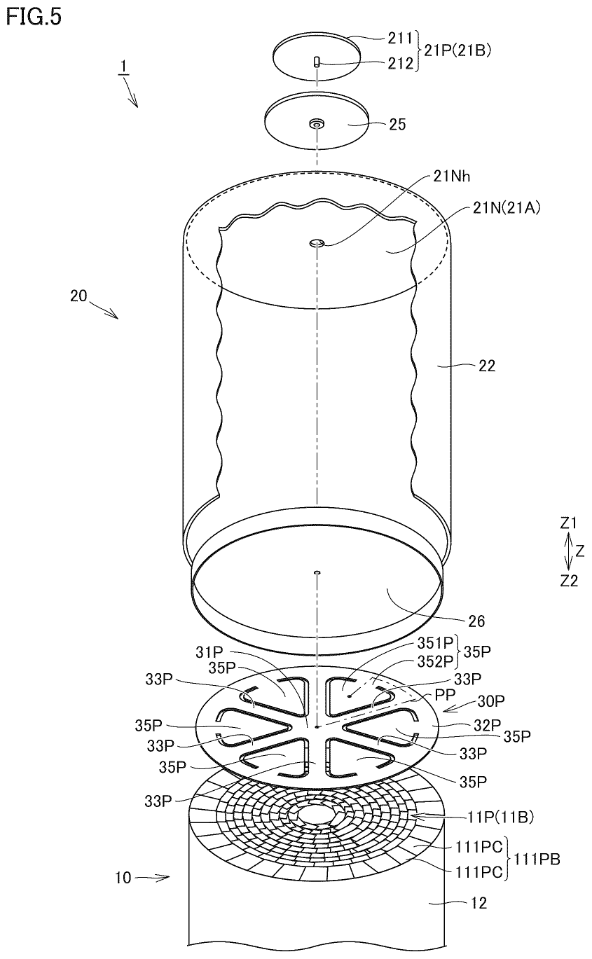

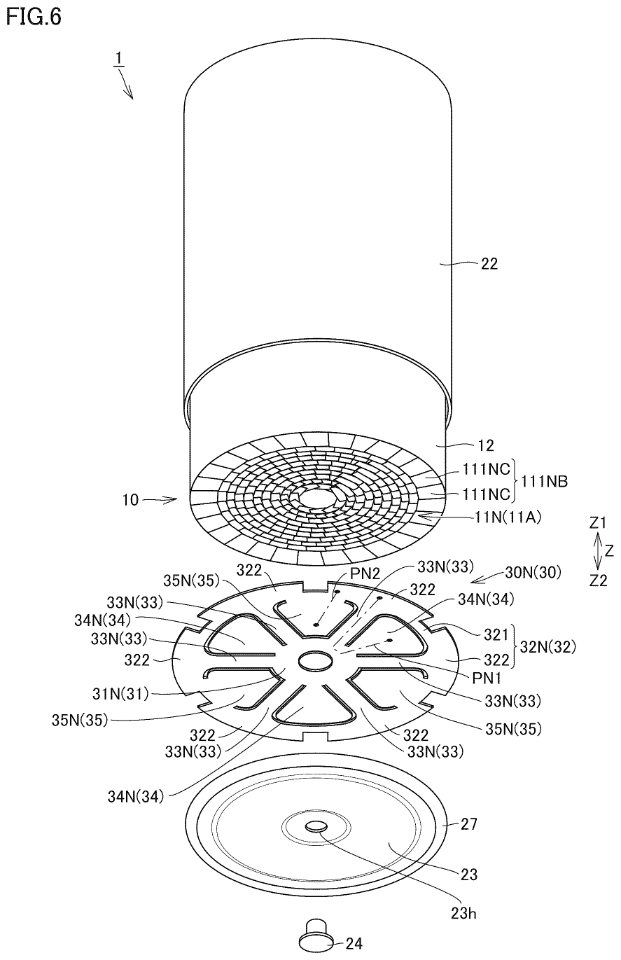

Next, the case 20 will be described. FIG. 5 is an exploded perspective view of the power storage cell according to the first embodiment. FIG. 6 is another exploded perspective view of the power storage cell according to the first embodiment.

As illustrated in FIGS. 1 to 3, 5 and 6, the case 20 houses the wound electrode body 10. The case 20 includes a positive electrode terminal 21P, a negative electrode terminal 21N, a cylindrical wall 22, a sealing plate 23, a sealing plug 24, an external gasket 25, an internal gasket 26, and an annular gasket 27. In the first embodiment, the negative electrode terminal 21N is illustrated as an example of a first external terminal (21A) in the present disclosure, and the positive electrode terminal 21P is illustrated as an example of a second external terminal (21B) in the present disclosure.

The positive electrode terminal 21P is disposed on the first direction Z1 side of the wound electrode body 10. The positive electrode terminal 21P includes a disk member 211 and a rivet member 212. The disk member 211 is exposed to the outside. The rivet member 212 is connected to the disk member 211. The rivet member 212 extends from a center of the disk member 211 when viewed from the axial direction Z. The rivet member 212 is located approximately on the winding axis a of the wound electrode body 10. The rivet member 212 extends toward the second direction Z2 side. The positive electrode terminal 21P is made of, for example, aluminum.

The negative electrode terminal 21N is provided to be orthogonal to the axial direction Z. The negative electrode terminal 21N is formed with a through hole 21Nh. Therefore, the negative electrode terminal 21N has an annular outer shape when viewed from the axial direction Z. The negative electrode terminal 21N is disposed between the disk member 211 and the wound electrode body 10 in the axial direction Z. The rivet member 212 is inserted through the through hole 21Nh. The rivet member 212 extends into the interior of the case 20. The material for the negative electrode terminal 21N is not particularly limited, and may be aluminum, copper, stainless steel, or the like.

The cylindrical wall 22 is provided on the outer periphery of the wound electrode body 10. The cylindrical wall 22 covers the entire outer periphery of the wound electrode body 10. The cylindrical wall 22 has a cylindrical shape. An end portion of the cylindrical wall 22 on the first direction Z1 side is connected to the negative electrode terminal 21N. The cylindrical wall 22 is formed integrally with the negative electrode terminal 21N. The material for the cylindrical wall 22 is not particularly limited, and may be aluminum, copper, stainless steel, or the like.

An end portion of the cylindrical wall 22 on the second direction Z2 side is formed with a caulking member 22d. The caulking member 22d is formed in an annular shape along the circumferential direction of the wound electrode body 10. FIG. 5 and FIG. 6 illustrate the cylindrical wall 22 in a state before the caulking member 22d is formed.

The sealing plate 23 is connected to an end portion of the cylindrical wall 22 on the second direction Z2 side. The sealing plate 23 seals an opening of the cylindrical wall 22 on the second direction Z2 side. The caulking member 22d is caulked to the outer peripheral edge of the sealing plate 23. The sealing plate 23 may be connected to the cylindrical wall 22 by welding such as laser welding. The material for the sealing plate 23 is not particularly limited, and may be aluminum, copper, stainless steel, or the like.

The sealing plate 23 is formed with a through hole 23h. The through hole 23h may be used to inject an electrolytic solution (not shown) which will be housed in the case 20. The through hole 23h is formed in a center of the sealing plate 23 when viewed from the axial direction Z.

The sealing plug 24 is inserted through the through hole 23h of the sealing plate 23. Thus, the sealing plug 24 is fixed to the sealing plate 23. The sealing plug 24 and the through hole 23h may function as a pressure release valve for releasing an internal pressure of the case 20 when the internal pressure of the case 20 becomes excessively high.

The external gasket 25 is disposed between the positive electrode terminal 21P and the negative electrode terminal 21N. The outer gasket 25 is made of an insulating material. Thus, the external gasket 25 insulates the positive electrode terminal 21P and the negative electrode terminal 21N from each other. The external gasket 25 covers a surface of the disk member 211 on the second direction Z2 side. The rivet member 212 penetrates the external gasket 25 in the axial direction Z. The external gasket 25 covers an inner surface of the through hole 21Nh of the negative electrode terminal 21N in the radial direction.

The internal gasket 26 covers a surface of the negative electrode terminal 21N on the second direction Z2 side. The inner gasket 26 is made of an insulating material. Therefore, the internal gasket 26 insulates the wound electrode body 10 and the negative electrode terminal 21N from each other. The rivet member 212 further penetrates the internal gasket 26 in the axial direction Z. Therefore, the rivet member 212 is exposed to the interior of the case 20.

The annular gasket 27 has an annular outer shape. The annular gasket 27 covers the outer peripheral edge of the sealing plate 23. The annular gasket 27 is disposed between the outer peripheral edge of the sealing plate 23 and the caulking member 22d of the cylindrical wall 22. The annular gasket 27 may be made of an insulating material or a conductive material. The case 20 may not include the annular gasket 27.

In the present embodiment, the sealing plate 23 is insulated from the cylindrical wall 22 by the annular gasket 27, but the sealing plate 23 may be electrically connected to the cylindrical wall 22. In this case, the sealing plate 23 may be a negative electrode terminal.

In the present embodiment, the members of the case 20 on the first direction Z1 side includes the positive electrode terminal 21P, the negative electrode terminal 21N, and the external gasket 25. However, the case 20 may further include a top plate as one of the above-described members. The top plate may be disposed further on the inner peripheral side of the negative electrode terminal 21N, for example. The top plate may be disposed so as to be aligned with the positive electrode terminal 21P in the axial direction Z. The top plate may be insulated from the negative electrode terminal 21N. When the sealing plate 23 is used as a negative electrode terminal as described above, the top plate may be disposed to be electrically insulated from the sealing plate 23 to replace the negative electrode terminal 21N.

Next, the positive electrode current collector plate 30P will be described. As illustrated in FIGS. 2, 3 and 5, the positive electrode current collector plate 30P is disposed inside the case 20. The positive electrode current collector plate 30P is disposed on the first direction Z1 side of the wound electrode body 10.

The positive electrode current collector plate 30P is provided to electrically connect the positive electrode 11P and the positive electrode terminal 21P. The positive electrode current collector plate 30P is joined to the uncoated positive electrode portion 111PB of the positive electrode 11P by welding. Thus, the positive electrode current collector plate 30P is positively charged. The positive electrode current collector plate 30P is joined to an end portion of the rivet member 212 of the positive electrode terminal 21P on the second direction Z2 side by welding. Thus, the positive electrode terminal 21P is positively charged.

The internal gasket 26 is disposed between the positive electrode current collector plate 30P and the negative electrode terminal 21N. Thus, the positive electrode current collector plate 30P and the negative electrode terminal 21N are electrically insulated from each other. The internal gasket 26 extends to the outer periphery of the positive electrode current collector plate 30P. Thus, the internal gasket 26 is also disposed between the positive electrode current collector plate 30P and the cylindrical wall 22. Therefore, the positive electrode current collector plate 30P and the cylindrical wall 22 are electrically insulated from each other.

The positive electrode current collector plate 30P has a substantially disk-like outer shape. The positive electrode current collector plate 30P includes a central portion 31P, an outer peripheral edge 32P, a plurality of spokes 33P, and a plurality of pieces 35P.

The central portion 31P is disposed to overlap with the rivet member 212 of the positive electrode terminal 21P when viewed from the axial direction Z. The central portion 31P is connected to the case 20 to electrically connect the positive electrode current collector plate 30P to the positive electrode terminal 21P. Specifically, the central portion 31P is joined to the rivet member 212 of the positive electrode terminal 21P by welding.

The outer peripheral edge 32P is provided on the outer periphery of the positive electrode current collector plate 30P. The outer peripheral edge 32P is located on the outer peripheral side of the central portion 31P. The outer peripheral edge 32P extends in an annular shape centered on the central portion 31P. The outer peripheral edge 32P may be in contact with the uncoated positive electrode portion 111PB of the positive electrode 11P. However, the outer peripheral edge 32P is not joined to the uncoated positive electrode portion 111PB.

The plurality of spokes 33P are spaced apart from each other. The plurality of spokes 33P are arranged at equal intervals in the circumferential direction centered on the central portion 31P. The spokes 33P connect the central portion 31P and the outer peripheral edge 32P. The width of each spoke 33P from the central portion 31P to the outer peripheral edge 32P is substantially equal.

The plurality of pieces 35P are spaced apart from each other. The plurality of pieces 35P are arranged at equal intervals in the circumferential direction centered on the central portion 31P. The plurality of spokes 33P and the plurality of pieces 35P are arranged in such a manner that the plurality of spokes 33P and the plurality of pieces 35P are alternately arranged in the circumferential direction centered on the central portion 31P. The piece 35P extends from the outer peripheral edge 32P toward the central portion 31P. The piece 35P is connected to the positive electrode 11P. Specifically, the piece 35P is joined to the uncoated positive electrode portion 111PB of the positive electrode 11P by welding. FIG. 5 schematically illustrates a path PP on the positive electrode current collector plate 30P from a joint portion between the piece 35P and the uncoated positive electrode portion 111PB to a joint portion between the central portion 31P and the rivet member 212.

The piece 35P has a fan-shaped portion 351P and a neck portion 352P. The fan-shaped portion 351P is joined to the uncoated positive electrode portion 111PB of the positive electrode 11P by welding. The front end of the fan-shaped portion 351P faces the central portion 31P. The fan-shaped portion 351P extends toward the outer peripheral edge 32P along two spokes 33P adjacent to each other on both sides in the circumferential direction. Accordingly, the surface area of the fan-shaped portion 351P becomes relatively large, which makes it easier to weld the fan-shaped portion 351P to the uncoated positive electrode portion 111PB of the positive electrode 11P.

The neck portion 352P connects the outer peripheral edge 32P and the fan-shaped portion 351P. The neck portion 352P may be in contact with the uncoated positive electrode portion 111PB of the positive electrode 11P. However, the neck portion 352P is not joined to the uncoated positive electrode portion 111PB of the positive electrode 11P. The size of the neck portion 352P in the circumferential direction is smaller than the size of the outer peripheral edge of the fan-shaped portion 351P in the circumferential direction. Thus, the piece 35P is easy to bend at the neck portion 352P.

Hereinafter, an example method of welding the center portion 31P to the rivet member 212 in the present embodiment will be described. First, before the central portion 31P is welded to the rivet member 212, the fan-shaped portion 351P of the piece 35P is welded to the uncoated positive electrode portion 111PB of the positive electrode 11P in advance. Next, the welding device is inserted from the second direction Z2 side of the wound electrode body 10 along the winding axis a of the wound electrode body 10. Thereafter, the welding device is pressed against the central portion 31P from the second direction Z2 side to weld the central portion 31P to the rivet member 212. During this time, the connection portion between the spoke 33P and the central portion 31P and the connection portion between the spoke 33P and the outer peripheral edge 32P on the path PP are bent largely. Accordingly, the central portion 31P can easily displace in the axial direction Z relative to the piece 35P. Therefore, even if the welding device is pressed against the central portion 31P, the joint portion between the piece 35P and the uncoated positive electrode portion 111PB is prevent from being destroyed by the displacement of the central portion 31P. Thus, the positive electrode current collector plate 30P and the case 20 can be easily connected to each other.

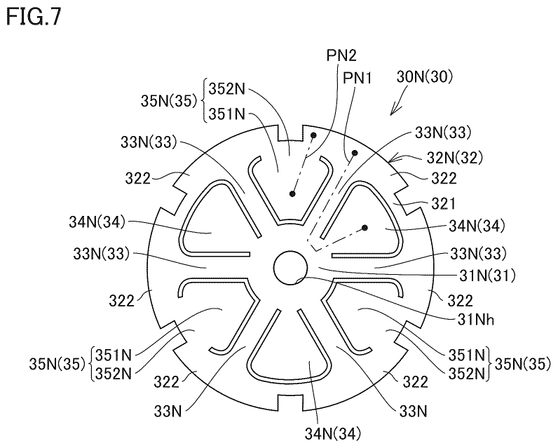

Next, the negative electrode current collector plate 30N will be described. FIG. 7 is a plan view of a negative electrode current collector plate according to the first embodiment. As illustrated in FIGS. 2, 3, 6 and 7, the negative electrode current collector plate 30N is disposed inside the case 20. The negative electrode current collector plate 30N is disposed on one side of the wound electrode body 10 in the axial direction Z, in other words, on the second direction Z2 side.

The negative electrode current collector plate 30N is provided to electrically connect the negative electrode 11N and the negative electrode terminal 21N. The negative electrode current collector plate 30N is joined to the uncoated negative electrode portion 111NB of the negative electrode 11N by welding. Thus, the negative electrode current collector plate 30N is negatively charged. The negative electrode current collector plate 30N is caulked to the cylindrical wall 22 by the caulking member 22d together with the outer peripheral edge of the sealing plate 23 and the annular gasket 27. Thus, the negative electrode terminal 21N connected to the cylindrical wall 22 is negatively charged.

The negative electrode current collector plate 30N has a substantially circular outer shape. The negative electrode current collector plate 30N includes a central portion 31N, an outer peripheral edge 32N, a plurality of spokes 33N, a plurality of first pieces 34N, and a plurality of second pieces 35N. In the first embodiment, the above-described members included in the negative electrode current collector plate 30N are illustrated as examples of a central portion (31), an outer peripheral edge (32), a spoke (33), a first piece (34), and a second piece (35) in the present disclosure, respectively.

The central portion 31N is disposed to overlap with the center of the wound electrode body 10 when viewed from the axial direction Z. Specifically, the central portion 31N is disposed to overlap with the winding axis a when viewed from the axial direction Z. The central portion 31N may be in contact with the uncoated negative electrode portion 111NB of the negative electrode 11N. However, the central portion 31N is not joined to the uncoated negative electrode portion 111NB.

The central portion 31N is formed with a through hole 31Nh. The through hole 31N of the central portion 31N overlaps with the through hole 23h of the sealing plate 23 when viewed from the axial direction Z. Thus, it is easy to inject the electrolytic solution from the through hole 23h. Further, when the internal pressure of the case 20 is being released, the negative electrode current collector plate 30N can be prevented from blocking the through hole 23h of the sealing plate 23. The sealing plug 24 is also inserted through the through hole 31Nh of the central portion 31N.

The outer peripheral edge 32N is provided on the outer periphery of the negative electrode current collector plate 30N. The outer peripheral edge 32N is located on the outer peripheral side of the central portion 31N. The outer peripheral edge 32N extends in an annular shape centered on the central portion 31P.

One of the outer peripheral edge 32N and the central portion 31N is connected to the case 20 to electrically connect the negative electrode current collector plate 30N to the negative electrode terminal 21N. In the present embodiment, the outer peripheral edge 32N is connected to the cylindrical wall 22 to electrically connect the negative electrode current collector plate 30N to the negative electrode terminal 21N. Specifically, the outer peripheral edge 32N is caulked to the cylindrical wall 22 by the caulking member 22d together with the outer peripheral edge of the sealing plate 23 and the annular gasket 27. Thus, the outer peripheral edge 32N is electrically connected to the negative electrode terminal 21N that is connected to the cylindrical wall 22.

The outer peripheral edge 32N has an annular base portion 321 and a plurality of outermost peripheral portions 322. The annular base portion 321 extends in an annular shape centered on the central portion 31N. The annular base portion 321 is not connected to the cylindrical wall 22. In other words, the annular base portion 321 is not caulked to the cylindrical wall 22 by the caulking member 22d.

Each of the plurality of outermost peripheral portions 322 extends outward from the annular base portion 321. The plurality of outermost peripheral portions 322 are spaced apart from each other. The plurality of outermost peripheral portions 322 are arranged at equal intervals in the circumferential direction centered on the central portion 31P. The plurality of outermost peripheral portions 322 are connected to the cylindrical wall 22. In other words, the plurality of outermost peripheral portions 322 are caulked to the cylindrical wall 22 by the caulking member 22d. By connecting the plurality of outermost peripheral portions 322 spaced apart from each other to the cylindrical wall 22 by caulking, it is possible to alleviate stress concentrated on the outer peripheral edge 32N.

The plurality of spokes 33N are spaced apart from each other. The plurality of spokes 33N are arranged at equal intervals in the circumferential direction centered on the central portion 31N. The spokes 33N connect the central portion 31N and the outer peripheral edge 32N. The spokes 33N have an outer diameter such that the width of each spoke from the central portion 31N to the outer peripheral edge 32N is substantially equal. The plurality of spokes 33N are aligned with the plurality of outermost peripheral portions 322 in the radial direction. Thus, when the spokes 33N are bent in one side of the axial direction Z, it is possible to prevent a shear force from acting between the annular base portion 321 and the outermost peripheral portion 322.

The plurality of first pieces 34N are spaced apart from each other. The plurality of first pieces 34N are arranged at equal intervals in the circumferential direction centered on the central portion 31N. Each of the plurality of first pieces 34N is adjacent to two spokes 33N located on both sides in the circumferential direction, respectively.

The first piece 34N extends from the central portion 31N toward the outer peripheral edge 32N. The first piece 34N is connected to the negative electrode 11N. Specifically, the first piece 34N is joined to the uncoated negative electrode portion 111NB of the negative electrode 11N by welding. FIG. 6 and FIG. 7 schematically illustrate a first path PN1 on the negative electrode current collector plate 30N from a joint portion between the first piece 34N and the uncoated negative electrode portion 111NB to a joint portion between the outer peripheral edge 32N and the cylindrical wall 22. The first piece 34N extends along two spokes 33N adjacent to each other. Accordingly, the surface area of the first piece 34N becomes relatively large, which makes it easier to weld the first piece 34N to the uncoated negative electrode portion 111NB of the negative electrode 11N.

The plurality of second pieces 35N are spaced apart from each other. The plurality of second pieces 35N are arranged at equal intervals in the circumferential direction centered on the central portion 31N. Each of the plurality of second pieces 35N is adjacent to two spokes 33N located on both sides in the circumferential direction, respectively. In other words, the first piece 34N and the second piece 35N are arranged side by side in the circumferential direction centered on the central portion 31N with the spoke 33N interposed therebetween.

The second piece 35N extends from the outer peripheral edge 32N toward the central portion 31N. The second piece 35N is connected to the negative electrode 11N. The second piece 35N is joined to the uncoated negative electrode portion 111NB of the negative electrode 11N by welding. FIG. 6 and FIG. 7 schematically illustrate a second path PN2 on the negative electrode current collector plate 30N from a joint portion between the second piece 35N and the uncoated negative electrode portion 111NB to a joint portion between the outer peripheral edge 32 and the cylindrical wall 22. The second piece 35N may not be joined to the uncoated negative electrode portion 111NB by welding.

The second piece 35N has a fan-shaped portion 351N and a neck portion 352N. The fan-shaped portion 351N is joined to the uncoated negative electrode portion 111NB of the negative electrode 11N by welding. The front end of the fan-shaped portion 351N faces the central portion 31N. The fan-shaped portion 351N extends along two spokes 33N adjacent to each other on both sides in the circumferential direction. Thus, the surface area of the fan-shaped portion 351N becomes relatively large, which makes it easier to weld the fan-shaped portion 351N to the uncoated negative electrode portion 111NB of the negative electrode 11N.

The neck portion 352N connects the outer peripheral edge 32N and the fan-shaped portion 351N. The neck portion 352N may be in contact with the uncoated negative electrode portion 111NB of the negative electrode 11N. However, the neck portion 352N is not joined to the uncoated negative electrode portion 111NB of the negative electrode 11N. The size of the neck portion 352N in the circumferential direction is smaller than the size of the outer peripheral edge of the fan-shaped portion 351N in the circumferential direction. Thus, the second piece 35N is easy to bend at the neck portion 352N.

Hereinafter, an example method of joining the outermost peripheral portion 322 of the outer peripheral edge 32N to the cylindrical wall 22 by caulking will be described. Before the outermost peripheral portion 322 is joined to the cylindrical wall 22 by caulking, the fan-shaped portions 351N of the first piece 34N and the second piece 35N are welded to the uncoated negative electrode portion 111NB of the negative electrode 11N in advance. Thereafter, the cylindrical wall 22 is caulked to form a caulked portion 22d. During this time, the connection portion between the spoke 33N and the central portion 31N and the connection portion between the spoke 33N and the outer peripheral edge 32N on the first path PN1 are bent largely. Accordingly, the outermost peripheral portion 322 can easily displace in the axial direction Z relative to the first piece 34N. Therefore, even if the outer peripheral edge 32N is displaced in the axial direction Z when the outer peripheral edge 32N is connected to the cylindrical wall 22, the joint portion between the first piece 34N and the uncoated negative electrode portion 111NB is prevented from being destroyed. Thus, the negative electrode current collector plate 30N and the case 20 can be easily connected to each other.

On the other hand, the second path PN2 is shorter than the first path PN1. Therefore, when the negative electrode current collector plate 30N is energized, the second path PN2 serves as a main conductive path. Since the second path PN2 is relatively short, it is possible to reduce heat generated during energization.

As described above, the power storage cell 1 according to the first embodiment of the present disclosure includes a wound electrode body 10, a case 20, and a current collector plate 30. The wound electrode body 10 includes a first electrode 11A and a second electrode 11B. The case 20 houses the wound electrode body 10 and includes a first external terminal 21A. The current collector plate 30 is disposed inside the case 20 on one side of the wound electrode body 10 in the axial direction Z. The current collector plate 30 is provided to electrically connect the first electrode 11A and the first external terminal 21A. The current collector plate 30 includes a central portion 31, an outer peripheral edge 32, a spoke 33, a first piece 34, and a second piece 35. The central portion 31 is disposed to overlap with the center of the wound electrode body 10 when viewed from the axial direction Z. The outer peripheral edge 32 is located on the outer peripheral side of the central portion 31. One of the outer peripheral edge 32 and the central portion 31 is connected to the case 20 to electrically connect the current collector plate 30 to the first external terminal 21A. The spoke 33 connects the central portion 31 and the outer peripheral edge 32. The first piece 34 extends from the central portion 31 toward the outer peripheral edge 32 and is connected to the first electrode 11A. The second piece 35 extends from the outer peripheral edge 32 toward the central portion 31 and is connected to the first electrode 11A.

According to the configuration described above, it is easy to form the connection between the current collector plate 30 and the case 20, and it is possible to suppress heat generation in the current collector plate 30.

From another point of view, according to the configuration described above, the power storage cell 1 can generate moderate heat when energized. As described in the first embodiment of the present disclosure, when for example the outer peripheral edge 32 is connected to the case 20, the path PN1 on the current collector plate 30 in which the first piece 34, the central portion 31, the spokes 33, and the outer peripheral edge 32 are connected in this order is relatively long. Therefore, when the electricity storage cell 1 is energized, the current collector plate 30 generates a relatively large amount of heat on the path PN1. On the other hand, the path on the current collector plate 30 which is constituted only by the second piece 35 and the outer peripheral edge 32 is relatively short. Therefore, heat generated in the path PN2 during energization is relatively small. Accordingly, it is possible to provide the power storage cell 1 that can generate moderate heat when energized.

Further, in the first embodiment of the present disclosure, the first piece 34 and the second piece 35 are arranged side by side in the circumferential direction centered on the central portion 31 with the spoke 33 interposed therebetween.

According to the configuration described above, the long conductive path (the first path PN1 in the present embodiment) on the current collector plate 30 in which heat generation during energization is relatively large and the short conductive path (the second path PN2 in the present embodiment) on the current collector plate 30 in which heat generation during energization is relatively small are arranged side by side in the circumferential direction. Thus, it is possible to reduce the deviation of the heat distribution in the circumferential direction when the current collecting plate 30 is energized.

Further, in the first embodiment of the present disclosure, the first piece 34 and the second piece 35 are welded to the first electrode 11A.

According to the configuration described above, the first piece 34 and the second piece 35 are more reliably fixed to the first electrode 11A. Consequently, a conductive path (the first path PN1 in the present embodiment) through the first piece 34 and a conductive path (the second path PN2 in the present embodiment) through the second piece 35 in the current collector plate 30 are formed more reliably.

Further, in the first embodiment of the present disclosure, the case 20 includes a cylindrical wall 22 that covers the entire outer periphery of the wound electrode body 10. The outer peripheral edge 32 is connected to the cylindrical wall 22 to electrically connect the current collector plate 30 to the first external terminal 21A.

According to the configuration described above, the conductive path from the current collector plate 30 to the first external terminal 21A includes the cylindrical wall 22 having a relatively large outer surface area. Therefore, the heat generated when the conduction path is energized can be easily dissipated from the outer surface of the cylindrical wall 22.

### Second Embodiment

Next, a power storage cell according to a second embodiment of the present disclosure will be described. The second embodiment of the present disclosure is different from the first embodiment of the present disclosure on the configuration of the first piece and the second piece in the negative electrode current collector plate. Therefore, the description of the same configuration and effect as those of the first embodiment of the present disclosure will not be repeated.

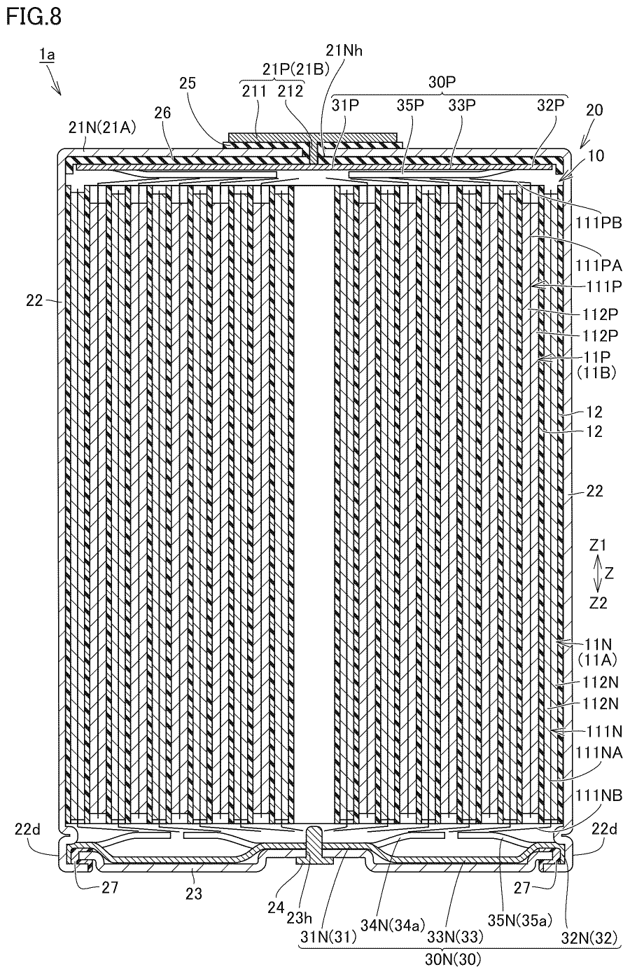

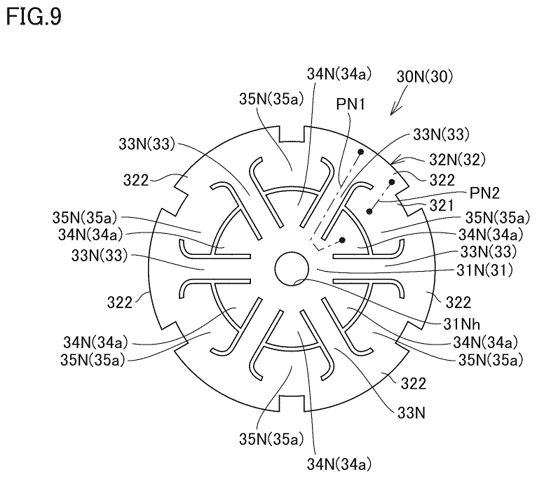

FIG. 8 is a cross-sectional view of the power storage cell according to the second embodiment. FIG. 9 is a plan view of a negative electrode current collector plate according to the second embodiment.

As illustrated in FIGS. 8 and 9, in the power storage cell la according to the second embodiment of the present disclosure, the first piece 34a and the second piece 35a are arranged side by side in the radial direction centered on the central portion 31.

According to the configuration described above, the first piece 34a and the second piece 35a can be arranged compactly. Accordingly, for example, the number of the first pieces 34a and the number of the second pieces 35a are larger than those in the first embodiment.

The plurality of spokes 33 and the plurality of first pieces 34a are arranged in such a manner that the spokes 33 and the first pieces 34a are alternately arranged in the circumferential direction centered on the central portion 31. The plurality of spokes 33 and the plurality of second pieces 35a are arranged in such a manner that the spokes 33 and the second pieces 35a are alternately arranged in the circumferential direction centered on the central portion 31.

### Third Embodiment

Next, a power storage cell according to a third embodiment of the present disclosure will be described. The third embodiment of the present disclosure is different from the first embodiment of the present disclosure mainly in that a positive electrode current collector plate 30P is illustrated as an example of a current collector plate in the present disclosure. Therefore, the description of the same configuration and effect as those of the third embodiment of the present disclosure will not be repeated.

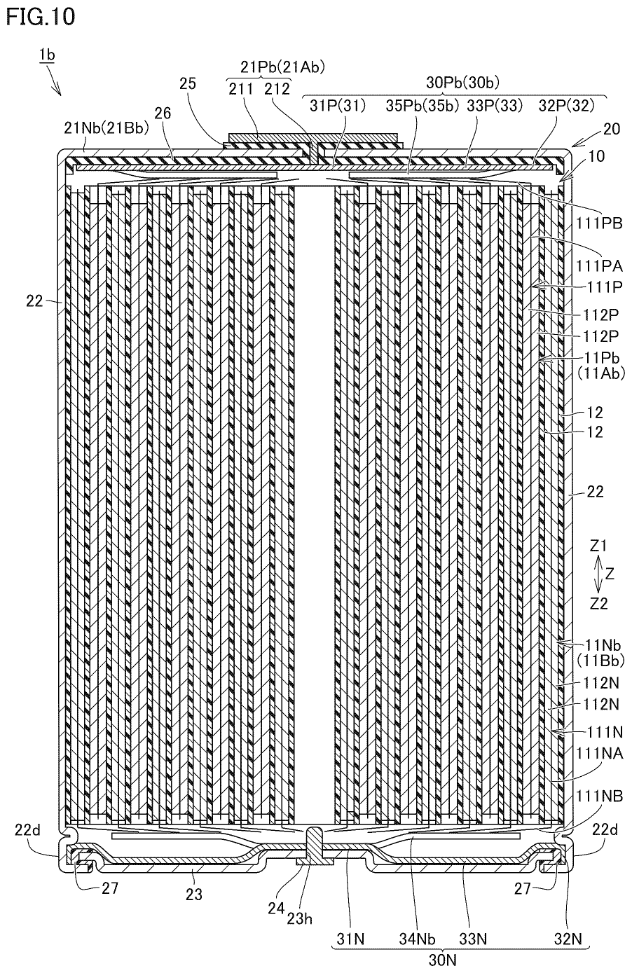

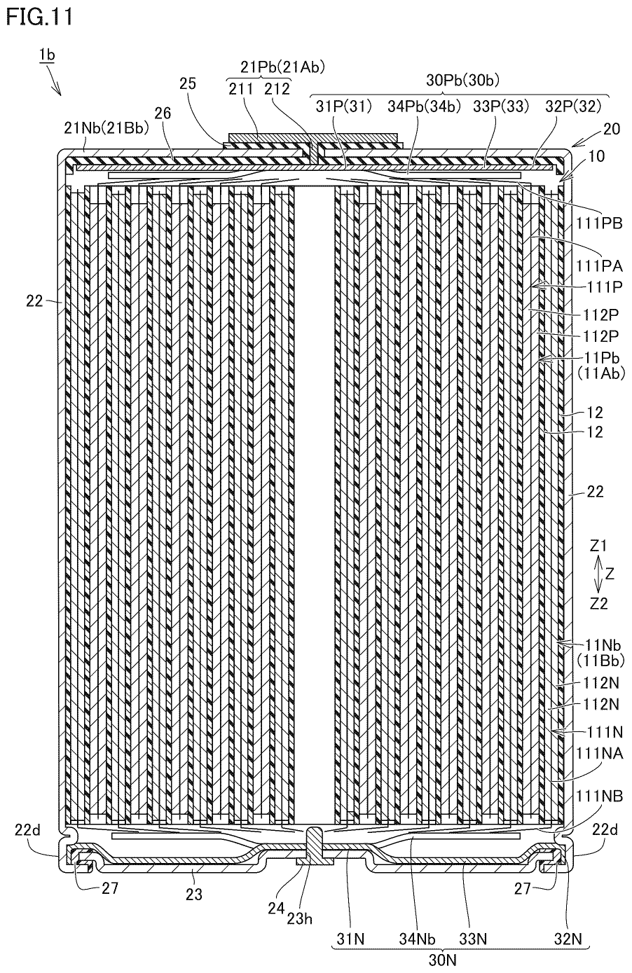

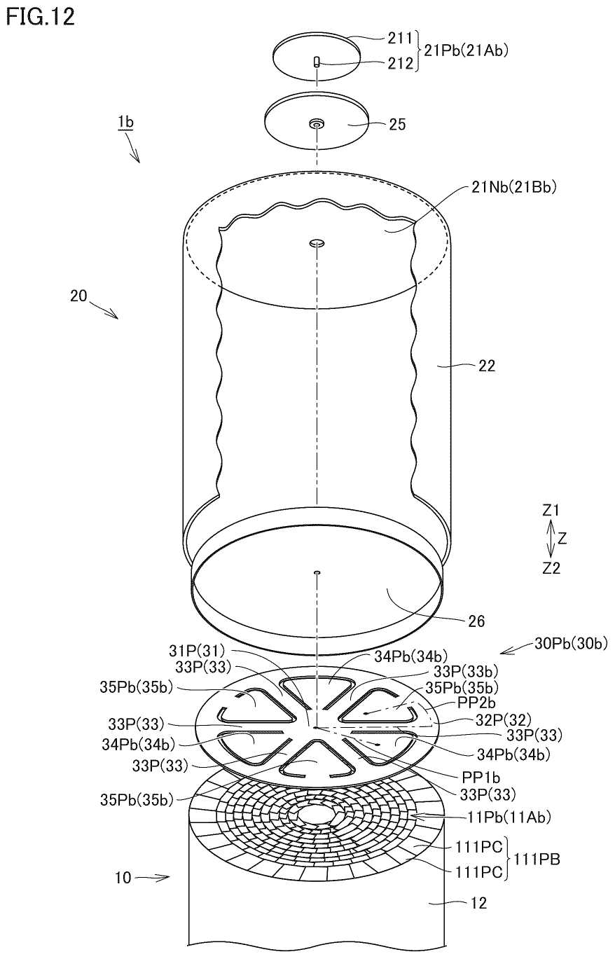

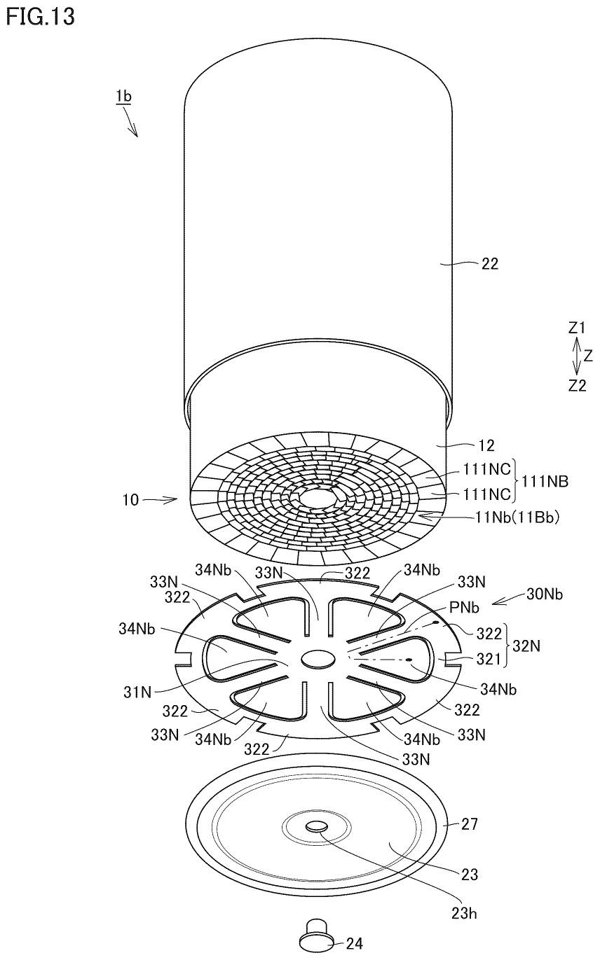

FIG. 10 is a cross-sectional view of the power storage cell according to the third embodiment. FIG. 11 is another cross-sectional view of the power storage cell according to the third embodiment. FIG. 12 is an exploded perspective view of the power storage cell according to the third embodiment. FIG. 13 is another exploded perspective view of the power storage cell according to the third embodiment.

As illustrated in FIGS. 10 to 13, in the power storage cell 1b according to the second embodiment of the present disclosure, a positive electrode 11Pb is illustrated as an example of a first electrode (11Ab) in the present disclosure, and a negative electrode 11Nb is illustrated as an example of a second electrode (11Ab) in the present disclosure. In addition, a positive electrode terminal 21Pb is illustrated as an example of a first external terminal (21Ab) in the present disclosure, and a negative electrode terminal 21Nb is illustrated as an example of a second external terminal (21Bb) in the present disclosure.

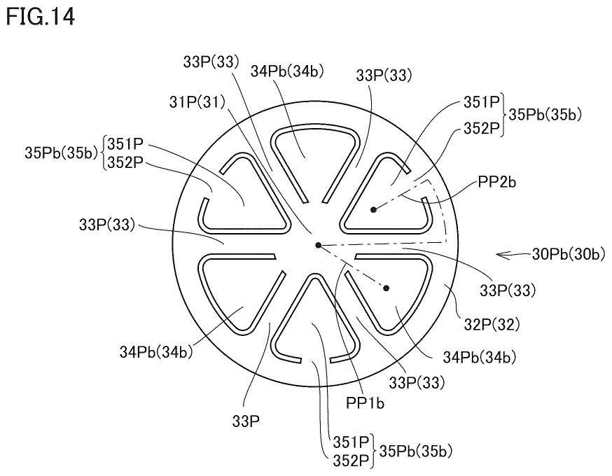

First, a positive electrode current collector plate 30Pb in the present embodiment will be described. FIG. 14 is a plan view of a positive electrode current collector plate according to a third embodiment. As illustrated in FIGS. 10 to 12 and FIG. 14, the positive electrode current collector plate 30Pb is illustrated as an example of the current collector plate (30b) in the present disclosure. The central portion (31P), the outer peripheral edge (32P), the spoke (33P), the first piece (34Pb), and the second piece (35Pb) included in the positive electrode current collector plate 30P are illustrated as examples of the central portion (31), the outer peripheral edge (32), the spoke (33), the first piece (34b), and the second piece (35b) in the present disclosure, respectively.

In the third embodiment, the positive electrode current collector plate 30P includes a plurality of first pieces 34Pb and a plurality of second pieces 35Pb.

The plurality of first pieces 34Pb are spaced apart from each other. The plurality of first pieces 34Pb are arranged at equal intervals in the circumferential direction centered on the central portion 31P. Each of the plurality of first pieces 34Pb is adjacent to two spokes 33P located on both sides in the circumferential direction, respectively.

The first piece 34Pb extends from the central portion 31P toward the outer peripheral edge 32P. The first piece 34Pb is connected to the positive electrode 11P. Specifically, the first piece 34Pb is joined to the uncoated positive electrode portion 111PB of the positive electrode 11P by welding. FIG. 14 schematically illustrates a first path PP1b on the positive electrode current collector plate 30Pb from a joint portion between the first piece 34Pb and the uncoated positive electrode portion 111PB to a joint portion between the central portion 31P and the rivet member 212. The first piece 34Pb extends along two spokes 33P adjacent to each other. Accordingly, the surface area of the first piece 34Pb becomes relatively large, which makes it easier to weld the first piece 34Pb to the uncoated positive electrode portion 111PB of the positive electrode 11P. The first piece 34Pb may not be joined to the uncoated positive electrode portion 111PB by welding.

The plurality of second pieces 35Pb are spaced apart from each other. The plurality of second pieces 35Pb are arranged at equal intervals in the circumferential direction centered on the central portion 31P. Each of the plurality of second pieces 35Pb is adjacent to two spokes 33P located on both sides in the circumferential direction, respectively. In other words, the first piece 34Pb and the second piece 35Pb are arranged side by side in the circumferential direction centered on the central portion 31P with the spoke 33P interposed therebetween.

The second piece 35Pb extends from the outer peripheral edge 32P toward the central portion 31P. The second piece 35Pb is connected to the positive electrode 11P. The second piece 35Pb is joined to the uncoated positive electrode portion 111PB of the positive electrode 11P by welding. FIG. 14 schematically illustrates a second path PP2b on the positive electrode current collector plate 30P from a joint portion between the second piece 35Pb and the uncoated positive electrode portion 111PB to a joint portion between the central portion 31P and the rivet member 212.

The second piece 35Pb has a fan-shaped portion 351P and a neck portion 352P. The fan-shaped portion 351P is joined to the uncoated positive electrode portion 111PB of the positive electrode 11P by welding. The front end of the fan-shaped portion 351P faces the central portion 31P. The fan-shaped portion 351P extends along two spokes 33P adjacent to each other on both sides in the circumferential direction. Accordingly, the surface area of the fan-shaped portion 351P becomes relatively large, which makes it easier to weld the fan-shaped portion 351P to the uncoated positive electrode portion 111PB of the positive electrode 11P.

The neck portion 352P connects the outer peripheral edge 32P and the fan-shaped portion 351P. The neck portion 352P may be in contact with the uncoated positive electrode portion 111PB of the positive electrode 11P. However, the neck portion 352P is not joined to the uncoated positive electrode portion 111PB of the positive electrode 11P. The size of the neck portion 352P in the circumferential direction is smaller than the size of the outer peripheral edge of the fan-shaped portion 351P in the circumferential direction. Thus, the second piece 35Pb is easy to bend at the neck portion 352P.

Hereinafter, an example method of welding the center portion 31P to the rivet member 212 in the present embodiment will be described. First, before the central portion 31P is welded to the rivet member 212, the fan-shaped portions 351P of the first piece 34Pb and the second piece 35Pb are welded to the uncoated positive electrode portion 111PB of the positive electrode 11P in advance. Next, the welding device is inserted from the second direction Z2 side of the wound electrode body 10 along the winding axis a of the wound electrode body 10. Thereafter, the welding device is pressed against the central portion 31P from the second direction Z2 side to weld the central portion 31P to the rivet member 212. During this time, the connection portion between the spoke 33P and the central portion 31P and the connection portion between the spoke 33P and the outer peripheral edge 32P on the second path PP2b are largely bent. Accordingly, the central portion 31P can easily displace in the axial direction Z relative to the second piece 35Pb. Therefore, even if the welding device is pressed against the central portion 31P, the joint portion between the second piece 35Pb and the uncoated positive electrode portion 111PB is prevent from being destroyed by the displacement of the central portion 31P. Thus, the positive electrode current collector plate 30Pb and the case 20 can be easily connected to each other.

On the other hand, the first path PP1b is shorter than the second path PP2b. Therefore, the first path PP1b serves as a main conductive path when the positive electrode current collector plate 30Pb is energized. Since the first path PP1b is relatively short, it is possible to reduce heat generated during energization.

Next, the negative electrode current collector plate 30Nb according to the third embodiment will be described. As illustrated in FIGS. 10, 11 and 13, in the third embodiment, the negative electrode current collector plate 30Nb includes a plurality of pieces 34Nb.

The plurality of pieces 34Nb are spaced apart from each other. The plurality of pieces 34Nb are arranged at equal intervals in the circumferential direction centered on the central portion 31N. The plurality of spokes 33N and the plurality of pieces 34Nb are arranged in such a manner that the spokes 33N and the pieces 34Nb are alternately arranged in the circumferential direction centered on the central portion 31N.

The piece 34Nb extends from the central portion 31N toward the outer peripheral edge 32N. The piece 34Nb is connected to the negative electrode 11N. Specifically, the piece 34Nb is joined to the uncoated negative electrode portion 111NB of the negative electrode 11N by welding. FIG. 13 schematically illustrates a path PNb on the negative electrode current collector plate 30N from a joint portion between the piece 34Nb and the uncoated negative electrode portion 111NB to a joint portion between the outer peripheral edge 32N and the cylindrical wall 22. The piece 34Nb extends along two spokes 33N adjacent to each other. Accordingly, the surface area of the piece 34Nb becomes relatively large, which makes it easier to weld the piece 34Nb to the uncoated negative electrode portion 111NB of the negative electrode 11N.

Hereinafter, an example method of joining the outermost peripheral portion 322 of the outer peripheral edge 32N and the cylindrical wall 22 by caulking will be described. Before the outermost peripheral portion 322 is joined to the cylindrical wall 22 by caulking, the piece 34Nb is welded to the uncoated negative electrode portion 111NB of the negative electrode 11N in advance. Thereafter, the cylindrical wall 22 is caulked to form a caulked portion 22d. During this time, the connection portion between the spoke 33N and the central portion 31N and the connection portion between the spoke 33N and the outer peripheral edge 32N on the path PNb are bent largely. Accordingly, the outermost peripheral portion 322 can easily displace in the axial direction Z relative to the piece 34Nb. Therefore, even if the outer peripheral edge 32N is displaced in the axial direction Z when the outer peripheral edge 32N is connected to the cylindrical wall 22, the joint portion between the piece 34Nb and the uncoated negative electrode portion 111NB is prevented from being destroyed. Thus, the connection between the negative electrode current collector plate 30Nb and the case 20 can be easily connected to each other.

As described above, the power storage cell 1b according to the third embodiment of the present disclosure includes a wound electrode body 10, a case 20, and a current collector plate 30b. The wound electrode body 10 includes a first electrode 11Ab and a second electrode 11B. The case 20 houses the wound electrode body 10 and includes a first external terminal 21Ab. The current collector plate 30b is disposed inside the case 20 on one side of the wound electrode body 10 in the axial direction Z. The current collector plate 30b is provided to electrically connect the first electrode 11Ab and the first external terminal 21Ab. The current collector plate 30b includes a central portion 31, an outer peripheral edge 32, a spoke 33, a first piece 34b, and a second piece 35b. The central portion 31 is disposed to overlap with the center of the wound electrode body 10 when viewed from the axial direction Z. The outer peripheral edge 32 is located on the outer peripheral side of the central portion 31. One of the outer peripheral edge 32 and the central portion 31 is connected to the case 20 to electrically connect the current collector plate 30b to the first external terminal 21Ab. The spoke 33 connects the central portion 31 and the outer peripheral edge 32. The first piece 34b extends from the central portion 31 toward the outer peripheral edge 32 and is connected to the first electrode 11Ab. The second piece 35b extends from the outer peripheral edge 32 toward the central portion 31 and is connected to the first electrode 11Ab.

According to the configuration described above, it is easy to form the connection between the current collector plate 30b and the case 20, and it is possible to suppress heat generation in the current collector plate 30b.

From another point of view, according to the configuration described above, the power storage cell 1b can generate moderate heat when energized. As described in the third embodiment of the present disclosure, for example, when the central portion 31 is connected to the case 20, the path PP2b on the current collector plate 30b in which the second piece 35b, the outer peripheral edge 32, the spokes 33, and the central portion 31 are connected in this order is relatively long. Therefore, when the electricity storage cell 1b is energized, the current collector plate 30b generates relatively large heat on the path PP2b. On the other hand, the path PP1b on the current collector plate 30b which is constituted only by the first piece 34b and the central portion 31 is relatively short. Therefore, heat generated in the path PP1b during energization is relatively small. Accordingly, it is possible to provide the power storage cell 1b that can generate moderate heat when energized.

Further, in the third embodiment of the present disclosure, the first piece 34b and the second piece 35b are arranged side by side in the circumferential direction centered on the central portion 31 with the spoke 33 interposed therebetween.

According to the configuration described above, the long conductive path (the second path PP2b in the present embodiment) on the current collector plate 30b in which heat generation during energization is relatively large and the short path (the first path PP1b in the present embodiment) on the current collector plate 30b in which the heat generation is relatively short are arranged side by side in the circumferential direction. Thus, it is possible to reduce the deviation of the heat distribution in the circumferential direction when the current collecting plate 30b is energized.

Further, in the third embodiment of the present disclosure, the first piece 34b and the second piece 35b are welded to the first electrode 11Ab.

According to the configuration described above, the first piece 34b and the second piece 35b are more reliably fixed to the first electrode 11Ab. Consequently, a conductive path (the first path PP1b in the present embodiment) through the first piece 34b and a conductive path (the second path PP2b in the present embodiment) through the second piece 35b in the current collector plate 30b are formed more reliably.

Further, in the third embodiment of the present disclosure, the first external terminal 21Ab is disposed to overlap with the central portion 31 when viewed from the axial direction Z. The central portion 31 is connected to the case 20 to electrically connect the current collector plate 30b to the first external terminal 21Ab.

According to the configuration described above, the conductive path from the current collecting plate 30b to the first external terminal 21Ab, which makes it possible to reduce heat generated in the conductive path.

### Fourth Embodiment

Next, a power storage cell according to a fourth embodiment of the present disclosure will be described. The fourth embodiment of the present disclosure is different from the third embodiment of the present disclosure on the configuration of the first piece and the second piece in the positive electrode current collector plate. Therefore, the description of the same configuration and effect as those of the third embodiment of the present disclosure will not be repeated.

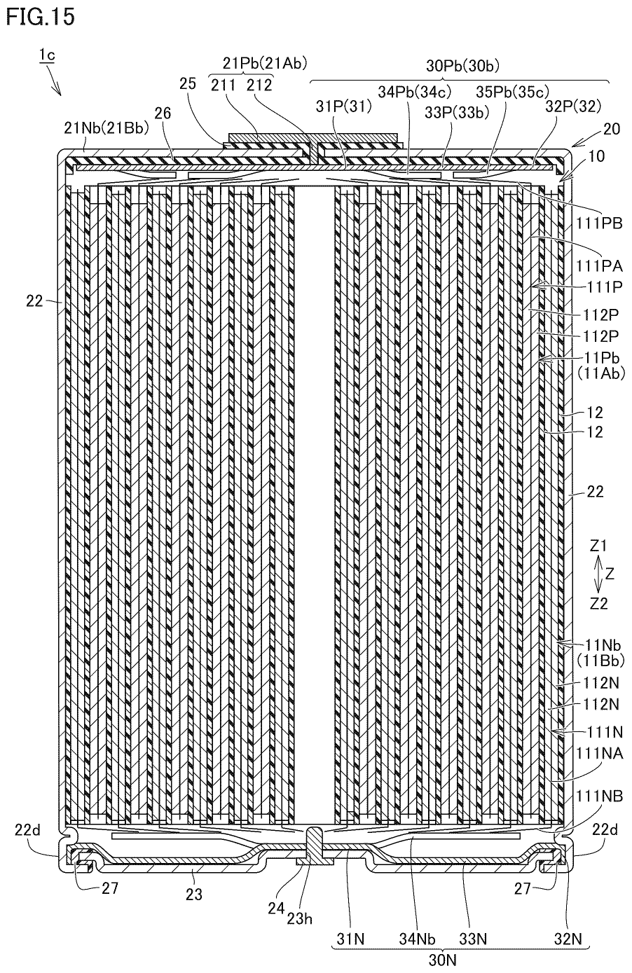

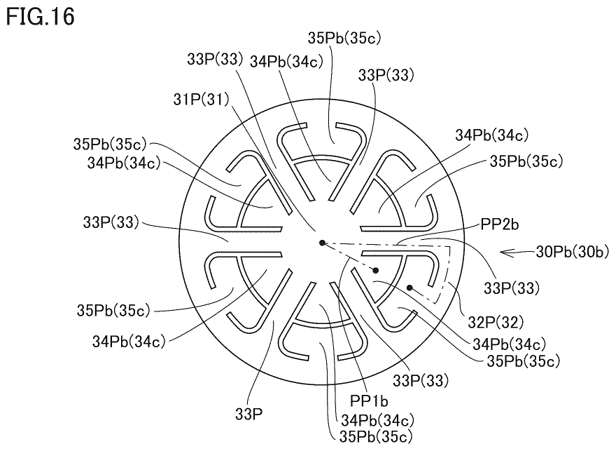

FIG. 15 is a plan view of the power storage cell according to the fourth embodiment. FIG. 16 is a plan view of a positive electrode current collector plate according to the fourth embodiment.

As illustrated in FIGS. 15 and 16, in the power storage cell 1c according to the fourth embodiment of the present disclosure, the first piece 34c and the second piece 35c are arranged side by side in the radial direction centered on the central portion 31.

According to the configuration described above, the first piece 34c and the second piece 35c can be arranged compactly. Accordingly, for example, the number of the first pieces 34c and the number of the second pieces 35c are larger than those in the third embodiment.

The plurality of spokes 33 and the plurality of first pieces 34c are arranged in such a manner that the spokes 33 and the first pieces 34c are alternately arranged in the circumferential direction centered on the central portion 31. The plurality of spokes 33 and the plurality of second pieces 35c are arranged in such a manner that the spokes 33 and the second pieces 35c are alternately arranged in the circumferential direction centered on the central portion 31.

### Fifth Embodiment

Next, a power storage cell according to a fifth embodiment of the present disclosure will be described. The fifth embodiment of the present disclosure is different from the power storage cell 1b according to the third embodiment of the present disclosure in that a negative electrode current collector plate is not provided. Therefore, the configuration and effect of the third embodiment of the present disclosure and the fluctuation will not be described repeatedly.

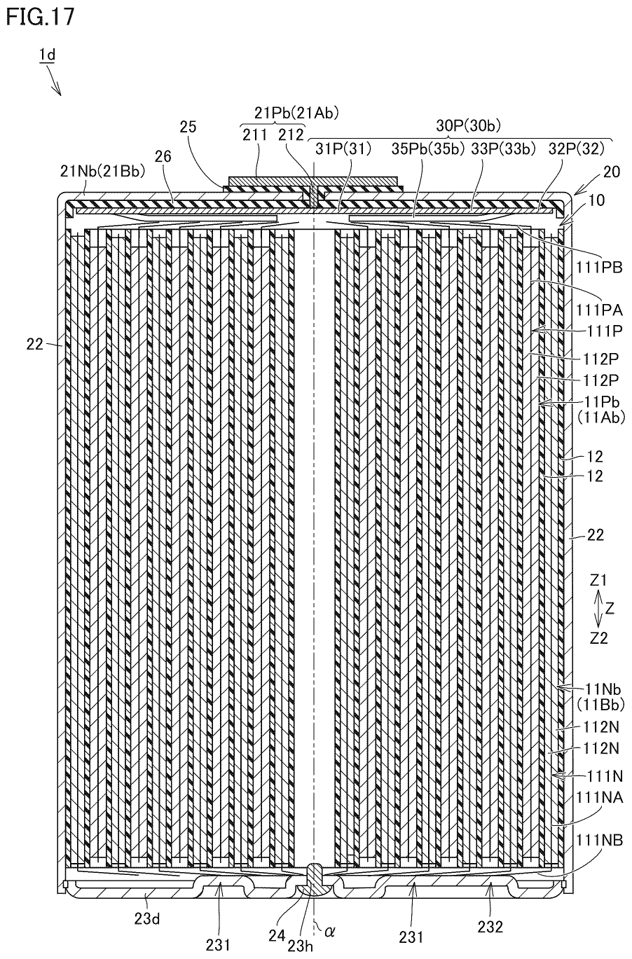

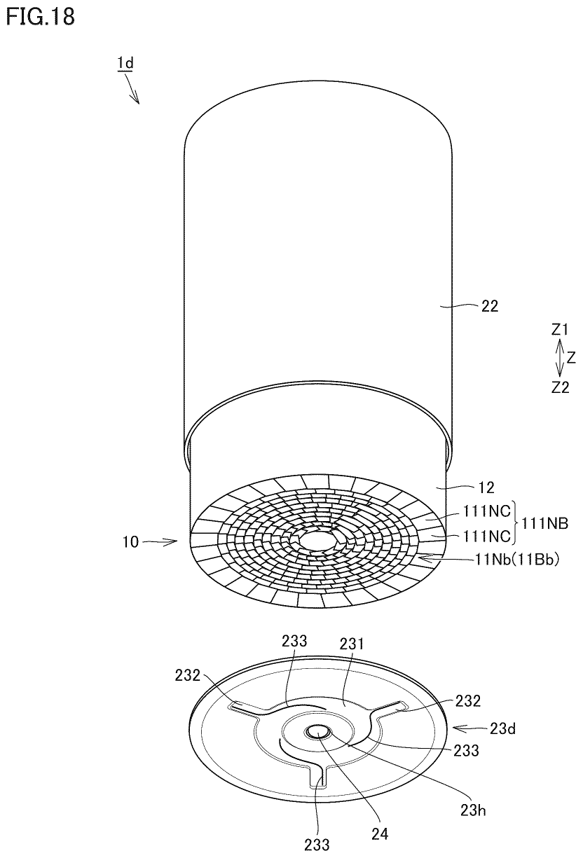

FIG. 17 is a cross-sectional view of the power storage cell according to the fifth embodiment. FIG. 18 is an exploded perspective view of the power storage cell according to the fifth embodiment.

As illustrated in FIGS. 17 and 18, in the power storage cell 1d according to the fifth embodiment, the case 20 does not include an annular gasket.

An outer peripheral edge of a sealing plate 23d in the present embodiment is connected to the cylindrical wall 22 by welding such as laser welding. Therefore, in the present embodiment, the cylindrical wall 22 is not provided with a caulking member.

In the present embodiment, the sealing plate 23d is provided to electrically connect the negative electrode 11N and the negative electrode terminal 21N. The sealing plate 23d is joined to the uncoated negative electrode portion 111NB of the negative electrode 11N by welding. Thus, the sealing plate 23d is negatively charged. The negative electrode terminal 21N connected to the cylindrical wall 22 is negatively charged. The sealing plate 23d may be a negative electrode terminal.

The sealing plate 23d has an annular ridge portion 231, a plurality of radial ridge portions 232, and a plurality of welded portions 233. When viewed from the axial direction Z, the annular ridge portion 231 extends in an annular shape about the winding axis a of the wound electrode body 10. The annular ridge portion 231 protrudes toward the first direction Z1 side. In other words, the annular ridge portion 231 protrudes toward the wound electrode body 10. The annular ridge portion 231 is in contact with the uncoated negative electrode portion 111NB of the negative electrode 11N.

The plurality of radial ridge portions 232 are arranged so as to be separated from each other in the circumferential direction about the winding axis a of the wound electrode body 10 when viewed from the axial direction Z. The plurality of radial ridge portions 232 are arranged at equal intervals in the circumferential direction.

Each of the plurality of radial ridge portions 232 extends in the radial direction about the winding axis a of the wound electrode body 10. The radial ridge portion 232 is continuous with the annular ridge portion 231.

The radial ridge portion 232 protrudes toward the first direction Z1 side. In other words, the radial ridge portion 232 protrudes toward the wound electrode body 10. The radial ridge portion 232 is in contact with the uncoated negative electrode portion 111NB of the negative electrode 11N.

The plurality of welded portions 233 are portions of the sealing plate 23d that are joined to the uncoated negative electrode portion 111NB by welding. The plurality of welded portions 233 are formed on the annular ridge portion 231. On the annular ridge portion 231, the plurality of welded portions 233 are formed to extend along the circumferential direction. The plurality of welded portions 233 are formed on a corresponding one of the plurality of radial ridge portions 232. On the radial ridge portion 232, the welded portion 233 is formed to extend along the radial direction. The annular ridge portion 231 and the plurality of radial protrusions 232 may be thinner than the other portions of the sealing plate 23d. This facilitates the formation of the welded portion 233.

In the description of the embodiments described above, appropriate configurations may be combined with each other. For example, the positive electrode current collector plate in one embodiment may be combined with the negative electrode current collector plate in another embodiment.

Although the embodiments of the present invention have been described, it should be understood that the embodiments disclosed herein are illustrative and non-restrictive in all respects. The scope of the present invention is defined by the scope of the claims and encompasses all modifications equivalent in meaning and scope to the claims.

What is claimed is:

1. A power storage cell comprising:
a wound electrode body that includes a first electrode and a second electrode;
a case that houses the wound electrode body and includes a first external terminal; and
a current collector plate that is disposed inside the case on one side of the wound electrode body in an axial direction and is provided to electrically connect the first electrode and the first external terminal,
wherein the current collector plate includes a central portion, an outer peripheral edge, a spoke, a first piece, and a second piece,
the central portion is disposed to overlap with a center of the wound electrode body when viewed from the axial direction,
the outer peripheral edge is located on an outer peripheral side of the central portion,
one of the outer peripheral edge and the central portion is connected to the case to electrically connect the current collector plate to the first external terminal,
the spoke connects the central portion and the outer peripheral edge,
the first piece extends from the central portion toward the outer peripheral edge and is connected to the first electrode, and
the second piece extends from the outer peripheral edge toward the central portion and is connected to the first electrode.

2. The power storage cell according to claim 1, wherein
the first piece and the second piece are arranged in a circumferential direction centered on the central portion with the spoke interposed therebetween.

3. The power storage cell according to claim 1, wherein
the first piece and the second piece are arranged in a radial direction centered on the central portion.

4. The power storage cell according to claim 1, wherein
the first piece and the second piece are welded to the first electrode.

5. The power storage cell according to claim 1, wherein
the case includes a cylindrical wall that covers the entire outer periphery of the wound electrode body, and
the outer peripheral edge is connected to the cylindrical wall to electrically connect the current collector plate to the first external terminal.

6. The power storage cell according to claim 1, wherein
the first external terminal is disposed to overlap with the central portion when viewed from the axial direction, and
the central portion is connected to the case to electrically connect the current collector plate to the first external terminal.
